(19) United States
(12) Patent Application Publication
(10) Pub. No.: US 2010/0114858 A1
(43) Pub. Date: May 6, 2010

(54) HOST-BASED SEED SELECTION ALGORITHM FOR WEB CRAWLERS

(75) Inventor: Pavel Dmitriev, Santa Clara, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/259,164

(22) Filed: Oct. 27, 2008

(51) Int. Cl. G06F 17/30

(52) U.S. Cl. 707/709; 707/E17.109; 707/E17.119

(57) ABSTRACT

A host-based seed selection process considers factors such as quality, importance and potential yield of hosts in a decision to use a document of a host as a seed. A subset of a plurality of hosts is determined, including some but not all of the plurality of the hosts, according to an indication of importance of the hosts, according to an expected yield of new documents for the hosts, and according to preferences for the markets the hosts belong to. At least one seed is generated for each host of the determined subset of hosts, wherein each generated at least one seed includes an indication of a document in the linked database of documents. The generated seeds are provided to be accessible by a database crawler.

### BACKGROUND

The present application relates to seed selection for crawling a linked database of documents, such as the World Wide Web. Web crawlers move from document to document using links present in the documents to move from one document to another document. As the crawler crawls, each document is processed so that information about the document can be determined and added to an index such as a search index. Since documents of the world wide web are constantly getting changed, added and/or deleted, it is desirable to continuously crawl the world wide web in order to continuously update the index. Otherwise, the index would soon become out of date.

A crawling process generally begins with a seed, which is a document that is used as a starting point for the crawling. What seeds are used has a direct influence on what documents are discovered and processed by the crawler. For example, the seeds may influence how many documents of a particular host are crawled (a host may be, for example, a particular web domain), how often new hosts and new documents are discovered, and how many pages are crawled from various “markets” (where, for example, a market correlates to a particular category of audience, such as an audience in a particular geographic area).

### SUMMARY

In accordance with an aspect, a host-based seed selection process is provided in which factors such as quality, importance and potential yield of hosts may be considered in a decision to use a document of a host as a seed. A seed is indicative of a document in a linked database of documents, wherein at least some of the documents are linked documents, at least some of the documents are linking documents, and at least some of the documents are both linked documents and linking documents. The documents are associated with a plurality of hosts such that each of the plurality of hosts has at least one of the documents associated with it and each document is associated with no more than one host.

In one example of such seed generation, a subset of the plurality of hosts is determined, including some but not all of the plurality of the hosts, according to an indication of importance of the hosts and according to an expected yield of new documents for the hosts. At least one seed is generated for each host of the determined subset of hosts, wherein each generated seed includes an indication of a document in the linked database of documents. The generated seeds are provided to be accessible by a crawler.

### BRIEF DESCRIPTION OF THE DRAWINGS

FIG. 1 graphically illustrates markets and hosts in the markets, with some hosts identified as important hosts and with some of the important hosts identified as important hosts with high expected yield of new documents.

FIG. 2 is a graph illustrating a market-by-market importance threshold usable to eliminate some hosts as possible seed contributors.

FIG. 3 and FIG. 4 are graphs illustrating an expected yield threshold usable to eliminate yet more hosts as possible seed contributors.

FIG. 5 is a graph illustrating proportional market value, usable to allocate seeds to markets in proportion to the value of those markets.

FIG. 6 is a flowchart illustrating an example of a host-based method to select seeds.

### DETAILED DESCRIPTION

The inventors have realized that the seed selection process can be improved to make crawling more efficient. For example, crawling may be more efficient if a particular selected seed results in a relatively large number of previously undiscovered documents being discovered and processed. As another example, crawling may be more efficient if a particular selected seed results in crawling of relatively more of more important hosts and documents, and fewer of less important hosts and documents. The inventors have also realized that it may be desirable to have a seed selection process for which a number of seeds to be selected may be an input parameter, and the resulting seeds may have a desirable distribution among markets. In general, the inventors have realized the desirability of a host-based seed selection process in which quality, importance and potential yield of hosts are considered in a decision to use a document of a host as a seed.

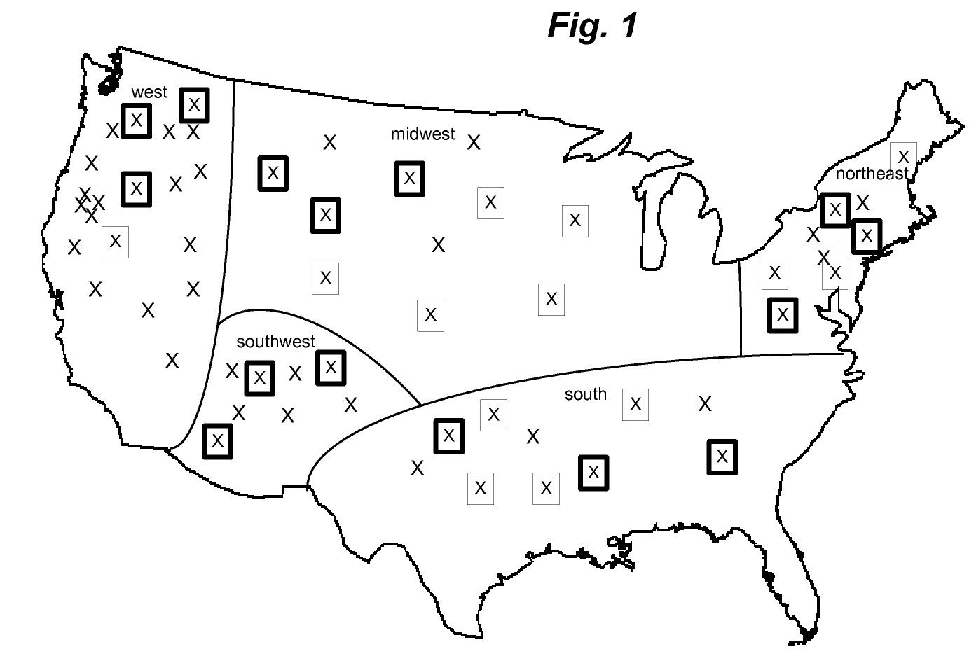

FIG. 1 is a very simplistic example that graphically illustrates markets and hosts in those markets, with some hosts identified as important hosts and with some of the important hosts identified as important hosts with high expected yield of new documents. A market is a collection of hosts that all have a common characteristic, generally with respect to users of those hosts. A typical market is geography-based, meaning that the subject matter of documents on the hosts of a market all concern or are focused on users from a particular geographic area. Examples of such markets include hosts in USA, hosts in China, hosts in Russia, etc. With respect to the world wide web, a host is generally a group of documents that are all addressed using a common domain name.

Turning to FIG. 1, the markets illustrated therein correspond to regions of the continental United States, including “west,” “mid-west,” “south,” “northeast” and “southwest.” Each host is designated by an “X.” While the number of hosts indicated in FIG. 1 is quite limited, in actuality, there are hundreds of thousands of hosts in markets that correspond to geographic regions of the continental United States. Also indicated in FIG. 1 are hosts that have been identified in some manner as important hosts. The hosts that have been identified as important hosts are those hosts designated by an “X” surrounded by a square. In addition, some of those hosts that have been identified as important hosts (designated by an “X” surrounded by a square) are hosts that not only have been identified as important hosts but, also, are hosts with a high expected yield of new documents. Such hosts are designated by an “X” surrounded by a bolded square.

For example, importance of hosts may be identified in a database of hosts by “host trust” metadata, which is a score, rating, and/or other attribute associated with a host and that generally provides an indication of a popularity, trustworthiness, reliability, quality, and/or other characteristic of a host. Furthermore, “important” hosts may be determined to be hosts whose host trust metadata value is above a particular threshold. For example, one can take as “host trust” the well-known PageRank value of the root page of the host. The term “host trust” generally refers to a score, rating, and/or other attribute associated with a host. A host trust value generally provides an indication of popularity, trustworthiness, reliability, quality, and/or other characteristic of a host.

The expected yield of documents for a host refers to a number of useful documents currently not known to the crawler expected to be yielded by crawling that host. In general, the expected yield for a host may be computed from statistics gathered during past crawls of that host. Later on in this description, we discuss one specific example computation to determine expected yield. An identification of hosts with a “high expected yield of new documents” may be determined, for example, by comparing a computed expected yield of documents for a host with a particular threshold value.

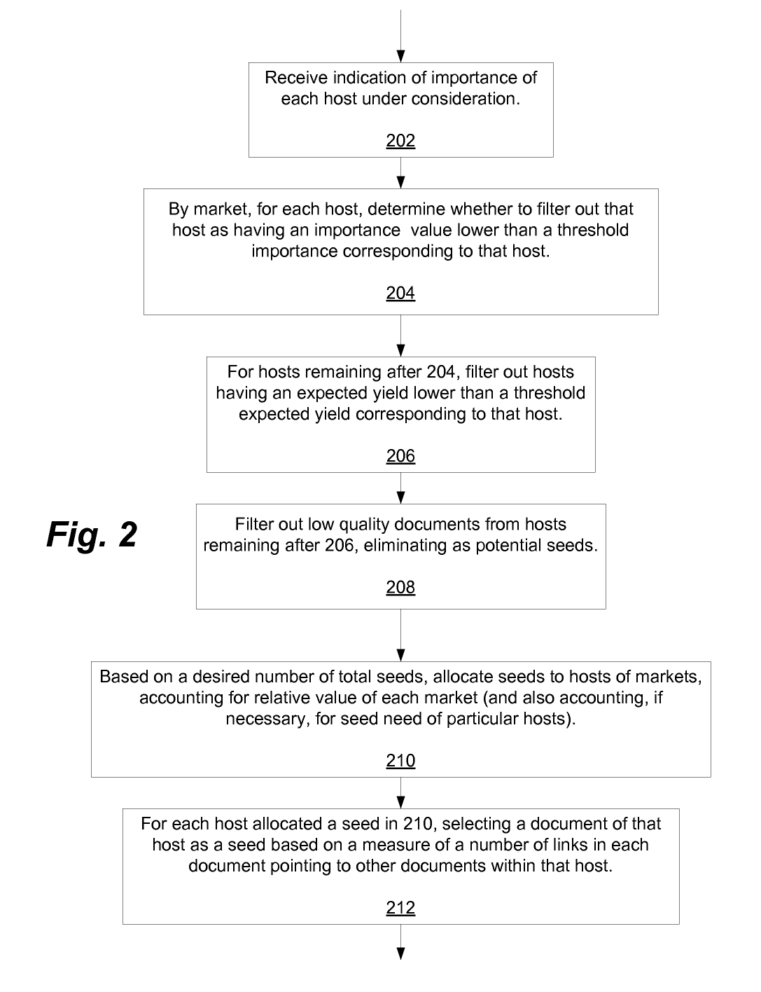

We now discuss a seed selection method, with reference to the FIG. 2 flowchart, in accordance with one example. Referring to FIG. 2, at 202, an indication is received of the importance of each host under consideration for contributing a seed. At 204, for each market, hosts having an importance that is below an importance threshold for that market are eliminated from consideration as a “seed host”—i.e., are eliminated as a host from which a seed may be selected. At 206, of those seeds not eliminated for having an importance below an importance threshold, additional hosts are eliminated that do not have more than a particular desired expected yield for that host.

At 208, for each host that remains after 206, documents of that host are eliminated from consideration as being a seed for that host based on a quality of the document as a seed. The quality of a document as a seed may be low, for example, as a result of having few outlinks, as a result of page being a spam page or having outlinks pointing to spam pages, or as a result of containing pornography content.

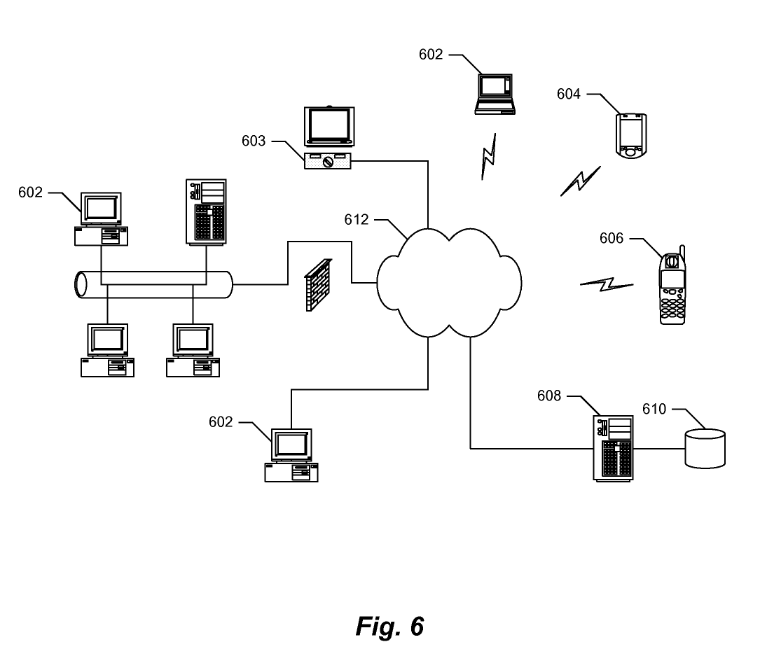

At 210, given the hosts that remain after 206, a total desired number of seeds are allocated to hosts of the markets, accounting for a relative value of each market (an example of which is discussed later, relative to FIG. 6), and also accounting for (if necessary) a seed need of particular hosts (such as, for example, if a desired number of seeds is less than the number of hosts that remain after 206, the hosts that have a greater need may be allocated seeds first). At 212, for each host allocated a seed, a document of that host is selected as the seed. For example, the document may be selected based on a measure of a number of links in each document of the host to other documents within that host. Note that, because all the low quality documents from the host were eliminated on step 208, the document ultimately selected as a seed is guaranteed to not be a low quality document. This is especially important because a seed is a starting point for a crawler, and starting from a low quality document is likely to lead to crawling many more low quality documents.

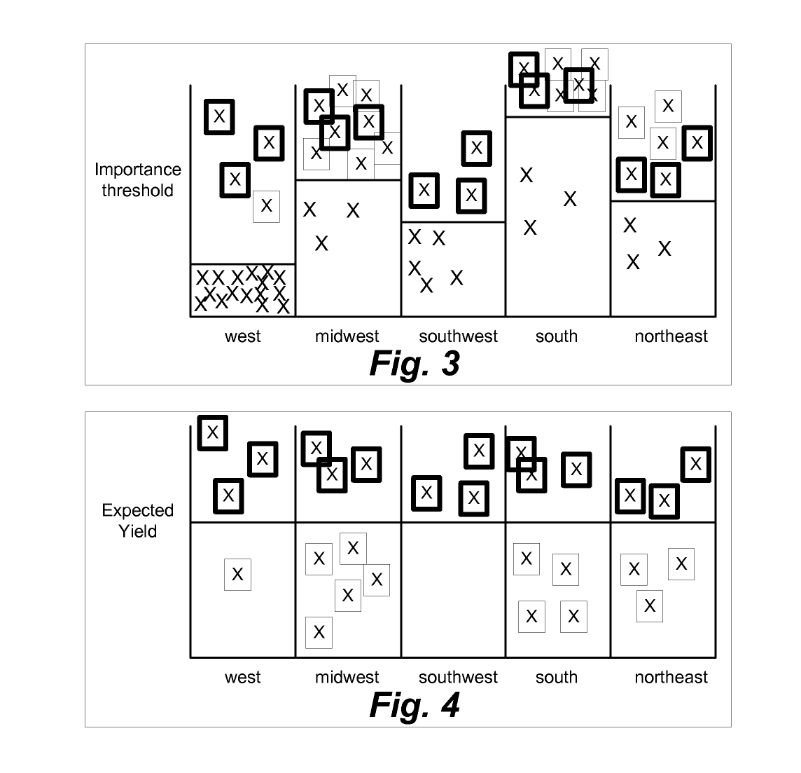

Having discussed the FIG. 2 flowchart, we now describe some example graphics to visually illustrate examples of operation in some of the steps of the FIG. 2 flowchart. For example, relative to step 204 in the FIG. 2 flowchart, FIG. 3 is a bar graph illustrating an example of importance thresholds that may be designated on a market-by-market basis. While a global importance threshold may be employed, employing importance thresholds on a market-by-market basis (or according to some other categorization) contributes to selecting seeds for an adequate number of hosts in markets that, in general, have relatively unimportant hosts. Put another way, it can keep hosts in relatively dominant markets (e.g., having relatively many hosts) from having so much influence that few or no seeds are selected for hosts in less dominant markets (e.g., having much fewer hosts).

The identification of hosts in FIG. 3 matches the identification of hosts in FIG. 1. Thus, for example, in FIG. 1, all the hosts in the “west” market that are identified by an “X” not surrounded by a square are, in FIG. 3, under the importance threshold line for the bar representing the “west” market. The situation is similar for the “midwest,” “southwest,” “south” and “northeast” markets. Meanwhile, taking the “west” market as an example, in FIG. 1, all the hosts in the “west” market that are identified by an “X” surrounded by a square (whether bolded square or normally-lined square), are above the importance threshold line for the bar representing the “west” market. Again, the situation is similar for the “midwest,” “southwest,” “south” and “northeast” markets. Looking still at FIG. 3, it can be seen that the hosts in the other markets are similarly categorized as being under the importance threshold line or above the importance threshold line.

Referring back to FIG. 2, in step 206, the hosts that remain after step 204 are filtered based on an expected yield. FIG. 4 is a bar graph illustrating an example of expected yield thresholds. In the FIG. 4 bar graph, the expected yield threshold is universal across markets though, in some examples, the expected yield threshold may be different on a market-by-market basis. Thus, for example, in FIG. 1, all the hosts in the “west” market that are identified by an “X” surrounded by a square (whether bolded or normally-lined square) are above the importance threshold line. In FIG. 4, those hosts in the “west” market that are above the importance threshold for the “west” market are either above the expected yield threshold for the “west” market (and, thus, are indicated by an “X” surrounded by a bolded square) or are below the expected yield threshold for the “west” market (and, thus, are indicated by an “X” surrounded by a normally-lined square). Looking still at FIG. 4, it can be seen that the hosts in each other market, that are above the importance threshold for that market, are similarly categorized as being under the expected yield line or above the expected yield line.

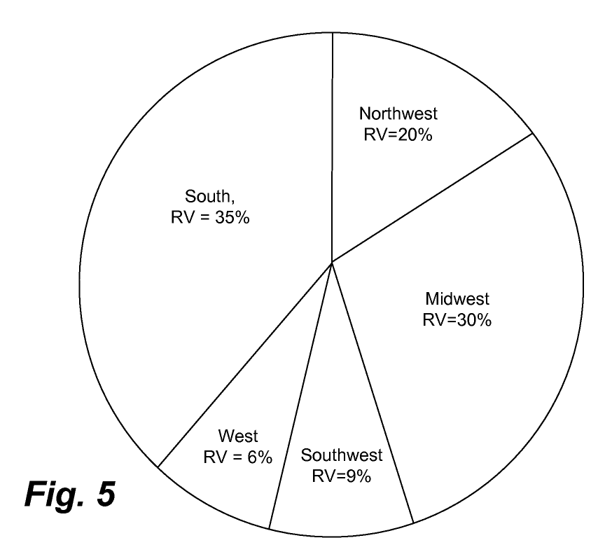

FIG. 5 is a pie chart illustrating an example of relative values for various markets as used, for example, in the allocating in step 210 of the FIG. 2 flowchart. The FIG. 5 pie chart show the relative values for the geographic markets discussed, as a proportion of the total value of all the geographic markets. More particularly, as discussed above, if the desired number of seeds to be allocated is less than the number of hosts that exceed an importance threshold and an expected yield, then the seeds may be allocated to hosts of markets based at least in part on relative values for the various markets. Such relative values may be based, for example, on a business decision as to the relative values. For example, the hosts for which seeds are generated may be hosts accessible via a web portal. The markets may be, for example, geography-based, such that the subject matter provided by hosts in each market is generally directed to user requests originating from the geographic area of that market. The relative values may be based on a business decision as to the relative values of requests from the users in the markets, such as from advertising or subscription revenue that is or can be achieved as a result of the user requests.

Embodiments of the present invention may be employed to facilitate evaluation of binary classification systems in any of a wide variety of computing contexts. For example, as illustrated in FIG. 6, implementations are contemplated in which users may interact with a diverse network environment via any type of computer (e.g., desktop, laptop, tablet, etc.) 602, media computing platforms 603 (e.g., cable and satellite set top boxes and digital video recorders), handheld computing devices (e.g., PDAs) 604, cell phones 606, or any other type of computing or communication platform.

According to various embodiments, applications may be executed locally, remotely or a combination of both. The remote aspect is illustrated in FIG. 6 by server 608 and data store 610 which, as will be understood, may correspond to multiple distributed devices and data stores.

The various aspects of the invention may also be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

We have described a mechanism for a host-based seed selection process in which quality, importance and potential yield of hosts are considered in a decision to use a document of a host as a seed. Thus, the seed selection process is improved to make crawling more efficient.

What is claimed is:

1. A computer-implemented method to generate a plurality of seeds, each seed indicative of a document in a linked database of documents, wherein at least some of the documents are linked documents, at least some of the documents are linking documents, and at least some of the documents are both linked documents and linking documents, and wherein the documents are associated with a plurality of hosts such that each of the plurality of hosts has at least one of the documents associated with it and each document is associated with no more than one host, the method comprising:
determining a subset of the hosts, including some but not all of the plurality of the hosts, according to an indication of importance the hosts and according to an expected yield of new documents for the hosts;
generating at least one seed for each host of the determined subset of hosts, wherein each generated seed includes an indication of a document in the linked database of documents; and
providing the generated seeds to be accessible by a database crawler.

2. The method of claim 1, wherein determining the subset of the hosts includes:
eliminating from consideration, from the plurality of hosts, those hosts whose indicated importance is below a threshold importance corresponding to that host.

3. The method of claim 2, wherein the threshold importance corresponding to each host is a function of a geographic region with which that host is determined to be associated.

4. The method of claim 1, wherein the expected yield for a host is based on a statistical analysis of an indication of previous experience with that host.

5. The method of claim 1, determining the subset of the hosts includes:
eliminating from consideration, from the plurality of hosts, those hosts whose expected yield is below a threshold expected yield corresponding to that host.

6. The method of claim 1, wherein:
generating at least one seed for each host includes, for each of at least one of the determined subset of hosts, determining a document of that host for which it is indicated has a particular quality characteristic relative to the quality characteristics of the other documents of that host.

7. The method of claim 6, wherein:
the quality characteristic is a measure of a number of links in that document pointing to other documents within that host.

8. The method of claim 6, wherein the quality characteristic of a document includes an indication of at least one of the group consisting of:
a probability that the document is SPAM;
a probability that the document is a corrupted forum/guestbook (here by forum or guestbook a document is meant such that any web user can contribute information to this document without permission of the owner of the document, and by corrupted forum/guestbook a forum/guestbook is meant that contains links to SPAM); and
a probability that the document is pornography.

9. The method of claim 1, further comprising:
allocating an available number of seeds to the markets proportionally based on an importance indication determined for each market.

10. A computer system to generate a plurality of seeds, each seed indicative of a document in a linked database of documents, wherein at least some of the documents are linked documents, at least some of the documents are linking documents, and at least some of the documents are both linked documents and linking documents, and wherein the documents are associated with a plurality of hosts such that each of the plurality of hosts has at least one of the documents associated with it and each document is associated with no more than one host, the computer system comprising at least one computing device configured to:
determine a subset of the hosts, including some but not all of the plurality of the hosts, according to an indication of importance the hosts and according to an expected yield of new documents for the hosts;
generate at least one seed for each host of the determined subset of hosts, wherein each generated seed includes an indication of a document in the linked database of documents; and
provide the generated seeds to be accessible by a database crawler.

11. The system of claim 10, wherein determining the subset of the hosts includes:
eliminating from consideration, from the plurality of hosts, those hosts whose indicated importance is below a threshold importance corresponding to that host.

12. The system of claim 11, wherein the threshold importance corresponding to each host is a function of a geographic region with which that host is determined to be associated.

13. The system of claim 11, wherein the expected yield for a host is based on a statistical analysis of an indication of previous experience with that host.

14. The system of claim 10, wherein determining the subset of the hosts includes:
eliminating from consideration, from the plurality of hosts, those hosts whose expected yield is below a threshold expected yield corresponding to that host.

15. The system of claim 10, wherein:
generating at least one seed for each host includes, for each of at least one of the determined subset of hosts, determining a document of that host for which it is indicated has a particular quality characteristic relative to the quality characteristics of the other documents of that host.

16. The system of claim 15, wherein:
the quality characteristic is a measure of a number of links in that document pointing to other documents within that host.

17. The system of claim 15, wherein the quality characteristic of a document includes an indication of at least one of the group consisting of:
a probability that the document is SPAM;
a probability that the document is a corrupted forum/guestbook (here by forum or guestbook a document is meant such that any web user can contribute information to this document without permission of the owner of the document, and by corrupted forum/guestbook a forum/guestbook is meant that contains links to SPAM); and
a probability that the document is pornography.

18. The system of claim 10, wherein the system is further configured to:
allocate an available number of seeds to the markets proportionally based on an importance indication determined for each market.

19. A computer-readable device having a plurality of seeds tangibly embodied thereon, each seed indicative of a document in a linked database of documents, wherein at least some of the documents are linked documents, at least some of the documents are linking documents, and at least some of the documents are both linked documents and linking documents, and wherein the documents are associated with a plurality of hosts such that each of the plurality of hosts has at least one of the documents associated with it and each document is associated with no more than one host, the seeds having been generated by:
determining a subset of the hosts, including some but not all of the plurality of the hosts, according to an indication of importance the hosts and according to an expected yield of new documents for the hosts;
generating at least one seed for each host of the determined subset of hosts, wherein each generated seed includes an indication of a document in the linked database of documents; and
providing the generated seeds to be accessible by a database crawler.
